(19) United States
(12) Patent Application Publication
(10) Pub. No.: US 2005/0056760 A1
(43) Pub. Date: Mar. 17, 2005

(54) Adjustable beam support

(76) Inventor: Bruce Carlson, Calgary (CA)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/973,171

(22) Filed: Oct. 25, 2004

Related U.S. Application Data
(63) Continuation-in-part of application No. 10/373,452, filed on Feb. 24, 2003.

(51) Int. Cl. B68G 5/00

(52) U.S. Cl. 248/354.3; 248/354.1

(57) ABSTRACT

An vertical strut has, at a lower end, an axial threaded portion rotationally engaged with a pier, and at an upper end, a strut cap terminating with an axial threaded plate. A beam support channel is engaged with the threaded plate by a fastener. The support channel provides opposing L-shaped sidewalls spaced apart for engaging a beam, and a U-shaped well depending downwardly from the L-shaped sidewalls for receiving a head of the fastener.

### BACKGROUND OF THE INVENTION

### RELATED APPLICATIONS

This application is a Continuation-In-Part Application of a prior filed, currently pending, application having serial number 10373452 and filing date of Feb. 24, 2003 and entitled: Adjustable Beam Support.

### FIELD OF THE INVENTION

This invention relates generally to structural supports and more particularly to a vertically adjustable beam support with cost effective construction and simple operation.

### DESCRIPTION OF RELATED ART

The following art defines the present state of this field:

Anderson, U.S. 2002/0014573 describes a device and method for leveling a machine using a base with a central opening and a bolt detachably insertable through the opening of the base. The head of the bolt will mate with the opening in the base. A nut can then be screwed onto the bolt in order to lock it to the base. Two additional nuts will hold a machine anchor on the bolt. The nuts adjacent the anchor can be vertically adjusted in order to level the machine. Openings re provided in the base for hold-down screws. These hold-down screws can be drilled through the openings of the base into the floor in order to hold the machine in position in final assembly. Before this time, these screws can be drilled into a pallet, shipping crate or other platform on which the machine is to be transported.

Bradshaw, U.S. Pat. No. 1,061,658 describes an adjustable support, embodying a tubular base section screw threaded externally at top and bottom, a base flange internally screw threaded, a boxing cap internally screw threaded engaging the upper end of said base section and having an internally screw threaded opening therethrough, an externally screw threaded section passing through said boxing cap, a guide collar mounted on said last mentioned section within the base section, a head casting carried on the upper end of said externally screw threaded section, a cap jounaled on the head casting, and an upper pipe section screw threaded into said cap.

Haroldson, U.S. Pat. No. 3,398,933 describes an adjustable pedestal for elevated flooring locking in its adjusted position solely by a downward force imposed by the weight of the flooring, which pedestal comprises a base member to be placed on a sub-floor, a head member for supporting the flooring, one of said members having a threaded rod thereon and the other of said members having a tubular section for the reception of said rod, said rod having a longitudinally extending keyway on its outer surface and said tubular section having a fixed radially inwardly extending key at all times fitting and slidable in said keyway to allow slidable movement of said rod with respect to said tubular section but at all times preventing rotative movement between said rod and said tubular section, and a nut threaded onto said rod and abutting the free end of said tubular section, the abutting surfaces of said nut and the free end of said tubular section having a plurality of circumferentially spaced cooperating recess and projection means adapted to mate and restrain turning movement of said nut with respect to said rod solely by the downward force imposed by the weight of the flooring on said nut.

Olvera, U.S. Pat. No. 3,645,054 describes an adjustable device for leveling floors, bases and other structures and having a cylindrical, elongate, threaded body supported at one end in an upright position and having at least one diametral slot in its other end of such width as to accommodate a flange formed on the structure to be leveled. An adjustable nut is threaded on the body between the ends of the latter and is adjustable toward and away from the slotted end of the body so as to vary the effective depth of the slot. Bearings preferably are supported in a retainer atop the adjusting nut to eliminate friction between the nut and the flange.

Albrecht et al., U.S. Pat. No. 4,558,544 describes an adjustable pedestal adapted to support individually removable panel members in accurate, edge-aligned relation and in a common horizontal that is level plane. The pedestal includes a head assembly supported on an upper end of a support. The head assembly includes a head member having a generally flat upper surface which is adjustable vertically, rotationally and laterally of the support rod. Abutment means adjustable along the support rod, is engaged by the head member and establishes a position of the head member wherein the upper surface resides in the horizontal plane. Clamping means clamps the head member to the support rod. Radially extending lugs extend above the upper surface of the head member. The arrangement is such that an adjacent pair of lugs of one pedestal cooperates with adjacent pairs of lugs from adjacent pedestals to define a panel-supporting surface which is horizontal and which coincides with said horizontal plane.

Av-Zuk, U.S. Pat. No. 4,685,258 describes an access flooring system including a plurality of adjustable height pedestals, which support a skeletal grid of stringers. The stringers, in turn, support a plurality of rectangular floor panels. Each pedestal includes a head for supporting not only stringers, which are registered with perpendicular edges of floor panels, but, in addition, stringers that extend diagonally. The diagonal stringers provide increased load capacity for the system and resist medial deflections of the panels.

McSwain, U.S. Pat. No. 5,277,405 describes a temporary, self-leveling support device having a screwjack body with a threaded hole formed centrally therein for engaging a threaded bolt. The bolt has a load bearing plate affixed thereon. The bolt can be rotated within the screwjack body to raise or lower the load-bearing surface. The screwjack body has two opposed support legs pivotally attached thereto, which extend down to form an A-frame support. The support legs have pivotally mounted feet, which can pivot to engage uneven surfaces thereby allowing the device to be self-loading. The legs are secured to each other by an adjustable tie bar cross member which can be adjusted to increase or decrease the distance between the support legs and thereby adjust the overall height and base dimensions of the device.

Propst, U.S. Pat. No. 5,333,423 describes a floor system having removable floor panels resting at their corners on support rings provided by vertically adjustable pedestal units. The upper ends of the pedestal units have hex-heads for receiving a height adjusting tool. Access to the hex-heads is obtained by removing cornercaps held in place by screws threaded into the hex-heads. The support rings do not turn while the pedestal units are being adjusted in height.

Kawai et al., U.S. Pat. No. 5,479,745 describes floor panel support legs supporting floor panels atop a floor slab and a double floor device uses such floor panel support legs. Each floor support leg is constituted by a pair of cylindrical first and second pedestal members and a fixing member for fixing the relative position between the first and second pedestal members, the first and second pedestal members having bottoms at their axial one end portions and thread portions at their inner and outer circumferential surfaces respectively so that they are thread-engaged with each other through their thread portions. The axial height of the support leg is set by the degree of thread engagement between the first and second pedestal members and the thus set height is fixed by the fixing member. Such support legs are arranged between a floor slab and floor panels at butted portions of the floor panels to support the floor panels to thereby constitute a double floor device. Thus, the support legs are capable of strongly supporting floor panels at a low position from a floor slab to thereby provide a low double floor device.

Collins, et al., U.S. Pat. No. 5,561,950 describes an adjustable pier block for leveling a deck or porch. A footing block or base is cast of concrete and a threaded rod is placed vertically therein. A coupling having internal threads and a plurality of flats on an outer surface thereof is threaded onto the rod. A U-shaped saddle member, sized to receive a joist or beam, has a connector attached to a bottom outer surface thereof. The connector is sized and shaped to slidingly receive a free end of the coupling against a load bearing surface or the bottom side of the saddle. A washer or disk, of made from a friction reducing material, can be inserted between the coupling and the load bearing surface for ease of operation. The coupling can be turned, by use of a wrench cooperating with the flats, in order to raise or lower the beam or joist for leveling a deck during construction thereof and at a later date after settling has occurred.

Buzon, U.S. Pat. No. 5,588,264 describes a device for supporting, leveling and attaching (where appropriate), an elevated building surface. The device can be raised or lowered by rotating a base member of the device. The device includes a flange member for the support of heavy loads. The device further includes a fluid pathway to remove fluids, such as water, and heat from the support device. The device can be used in outdoor or indoor environments and is capable of supporting the heavy loads applied by many types of building surfaces, such as heavy structural slabs.

Triplett, U.S. Pat. No. 6,345,474 describes a universal block made of concrete designed to be used with different size posts and beams. The pier block is a conical, six-sided structure and includes two concentrically aligned, post-receiving voids designed to receive the ends of a (4 times 4) or (6 times 6) inch post. The (6 times 6) inch void is positioned above the (4 times 4) inch void. Formed horizontally on the top surface of the pier block are two transversely aligned beam-receiving slots. Each beam-receiving slot includes a narrow and a wide slot longitudinally aligned. The wide slot is positioned above the narrow slot. A vertically aligned drain hole is formed through the pier block from the bottom surface of the (4 times 4) inch void to the bottom of the pier block, which allows water to drain from the post-receiving voids.

Kugler, U.S. Pat. No. 6,363,685 describes an adjustable support piece, which can selectively raise or lower the level of a building surface or industrial component such as a mechanical pump, etc. A base member, crown member, and threaded tubular stem which can be cut with a hand saw are provided and which can be selectively adjusted in height to raise or lower the height of the building surface. In one embodiment, a coupling may be used to interconnect two tubular stems together. Further, a crown coupling spacer may be used to moderately increase the total length of the adjustable support piece.

The prior art teaches adjustable structural supports, leveling devices, decking supports, floor panels supports, and adjustable pier blocks, but does not teach a beam support channel mounted on an upper end of a supporting strut where the strut provides a threaded lower portion engaging a pier rotationally for raising and lowering the channel. The channel is novel for its conformation having opposing L-shaped walls for engaging the beam and a U-shaped portion for receiving the head of a fastener so that the fastener does not interfere with the seating of the beam. The present invention fulfills these needs and provides further related advantages as described in the following summary.

### SUMMARY OF THE INVENTION

The present invention teaches certain benefits in construction and use which give rise to the objectives described below.

An vertical strut has, at a lower end, an axial threaded portion rotationally engaged with a pier, and at an upper end, a strut cap terminating with an axial threaded plate. A beam support channel is engaged with the threaded plate by a fastener. The support channel provides opposing L-shaped sidewalls spaced apart for engaging a beam, and a U-shaped well depending downwardly from the L-shaped sidewalls for receiving a head of the fastener.

A primary objective of the present invention is to provide an apparatus and method of use of such apparatus that provides advantages not taught by the prior art.

Another objective is to provide such an invention capable of supporting a beam by a strut with vertical adjustment.

A further objective is to provide such an invention capable of being turned by either a wrench or a removable rod.

A still further objective is to provide such an invention capable of considerably vertical adjustment into and out of a cavity within a pier.

A yet still further objective is to provide such an invention capable of receiving the beam in a yolk with a well capable of receiving a head of a bolt.

A still further objective is to provide a supporting channel having a conformation that enables a fastener to be out of contact with a beam resting in the channel.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an elevational view of the present invention in partial cross-section, showing a pier mounted strut supporting a beam at its upper end using a yolk bracket; wherein the strut has flats and a rod hole for turning the strut;

FIG. 2 is the same view as FIG. 1 rotated by 90 degrees and showing placement of a rod engaging the rod hole;

FIG. 3 is the same view as FIG. 2 showing placement of a wrench engaging the flats; and

FIG. 4 is an enlarged view of an upper portion of the invention of FIG. 1, showing further details of construction.

### DETAILED DESCRIPTION OF THE INVENTION

The above described drawing figures illustrate the invention in at least one of its preferred embodiments, which is further defined in detail in the following description.

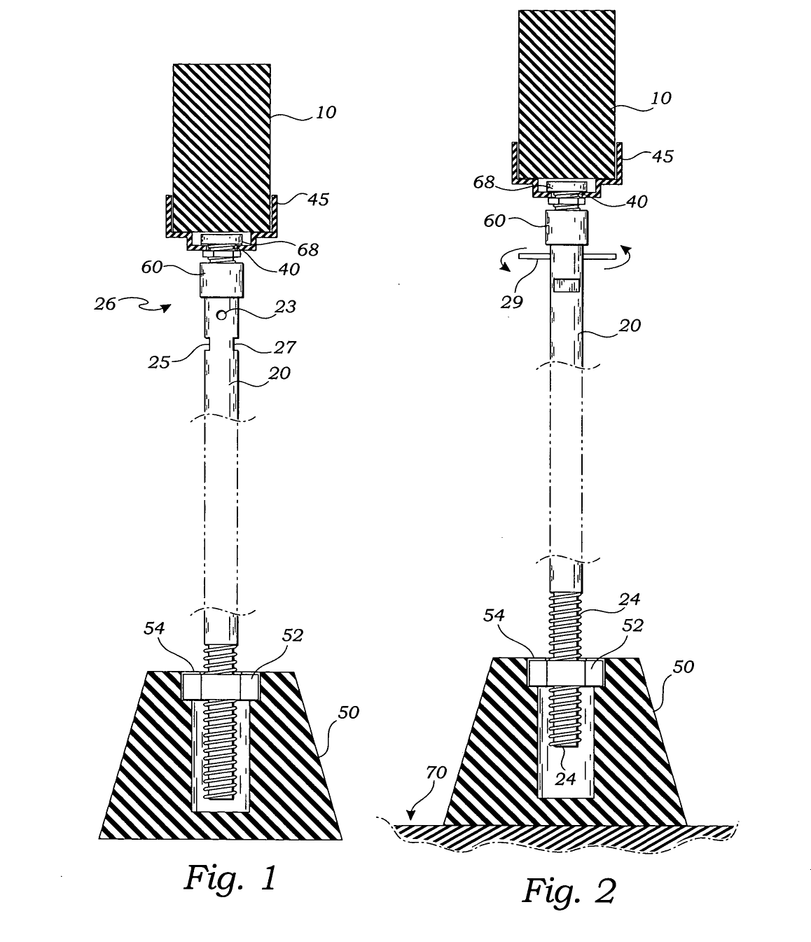

The present invention is an apparatus for supporting a structural beam 10 such as is used for supporting floors and ceilings in building construction, as shown in FIGS. 1-4. The apparatus provides a vertical strut 20, which may be made of wood or metal or ferro cement, for instance, and which provides at a lower end, an axially threaded portion 24 rotationally engaged with a pier 50 through pier nut 52. At an upper end 26 of strut 20, a strut cap 60 provides an axially threaded plate 64, as is best shown in FIG. 4 and has an internal annular flange 63. The annular flange 63 rests on the upper terminal end of strut 20 and the cap is of such size as to be able to rotate on strut 20. Strut cap 60 and plate 64 are fastened permanently together by welding or other well known means so that they form a single unit. Once cap 60 is engaged with bolt 68 it can be maintained in a stationary position as strut 20 rotates.

A beam support channel 43 having opposing L-shaped sidewalls 45 and a U-shaped well 40 engages the threaded plate 64 by a fastener 68, such as a bolt. The support channel's opposing L-shaped sidewalls 45 are spaced apart for lateral engagement with the beam 10, and the U-shaped well 40 depends downwardly from the L-shaped sidewalls 45 for receiving and harboring a head of the fastener 68. Preferably, locking nut 67 clamps the well 40 between it and the head of the fastener 68, thus permanently captures the bolt 68 onto the support channel 43.

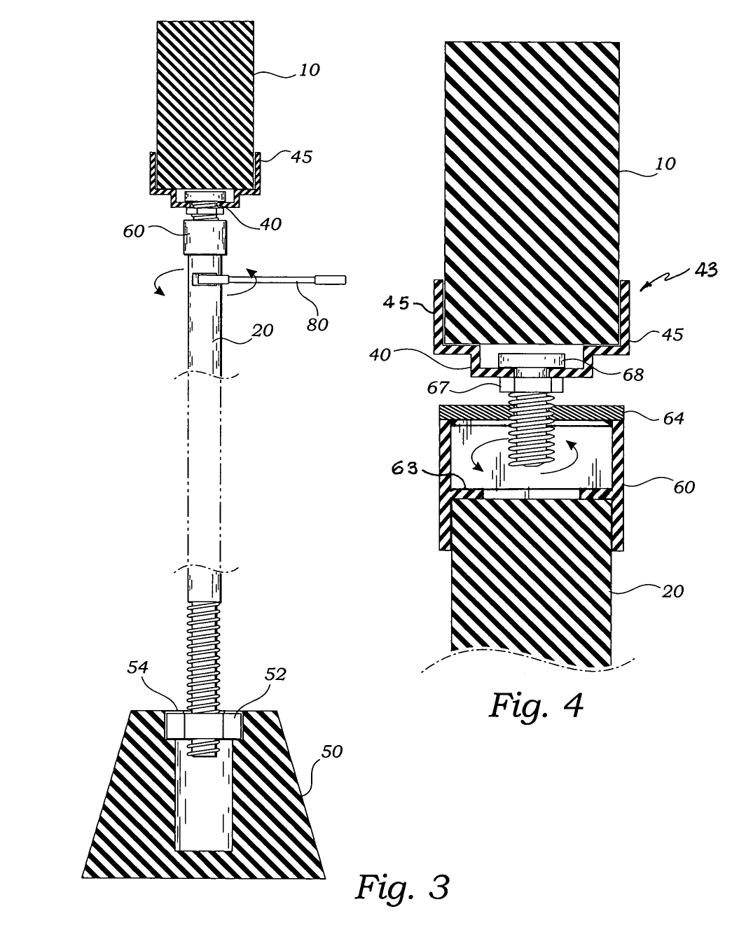

Preferably, the strut 20 provides a pair of opposing flat surfaces 25 and 27 (FIG. 1) for receiving a wrench 80 (FIG. 3) for applying turning torque to the strut 20. Alternately, the strut 20 may provide a hole 23 (FIG. 1) for receiving a rod 29 (FIG. 2) for applying the turning torque to the strut 20. By turning strut 20, the vertical position of the support channel 43 may be changed as can be seen by the relative positions of the threaded portion 24 within a pier nut 52 in FIGS. 1, 2 and 3.

Preferably, the pier nut 52 is engaged in a non-round hole 54 in the pier 50 as shown in FIGS. 1-3. The threaded portion 24 of the strut 20 is rotationally engaged with the pier nut 52 for supporting the strut with rotational cooperation so as to raise and lower the beam support channel 43 so as to adjust the supporting force that may be applied to the beam 10.

In use, the cap 60, along with plate 64 is engaged with bolt 68 and typically, although not necessarily, rotated to contact locking nut 67. In this position cap 60 is fixed. Next, strut 20 is engaged with pier nut 52 in pier 50 with enough threaded engagement to enable strut 20 to be moved directly under cap 60. Finally, strut 20 is rotated in pier nut 52 until the top terminal end of strut 20 enters cap 60 and seats itself against annular flange 63. Strut 20 can then be further rotated to address the required upwardly directed force on beam 10 through bolt 68 and the support channel 43.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An apparatus for supporting a beam, the apparatus comprising: a vertical strut providing at a lower end, an axial threaded portion rotationally engaged with a pier, and at an upper end, a strut cap, the cap engaging the strut and rotatable thereon; a beam support channel engaged with the cap; the support channel providing opposing L-shaped sidewalls spaced apart for engaging the beam, and a U-shaped well depending downwardly from the L-shaped sidewalls for receiving a head of the fastener.

2. The apparatus of claim 1 wherein the fastener provides a locking nut positioned for clamping the well between a head of the fastener and the locking nut.

3. The apparatus of claim 1 wherein the strut provides a pair of opposing flat surfaces for receiving a wrench for applying turning torque to the strut.

4. The apparatus of claim 1 wherein the strut provides a hole for receiving a rod for applying turning torque to the strut.

5. The apparatus of claim 1 wherein the pier provides an axially oriented base nut engaged in a non-round hole in the pier; the threaded portion of the strut rotationally engaged with the base nut for supporting the strut in rotational cooperation.

6. The apparatus of claim 1 wherein the strut cap provides an internal annular flange positioned for receiving the vertical strut
